(19) United States
(12) Patent Application Publication
(10) Pub. No.: US 2023/0342453 A1
(43) Pub. Date: Oct. 26, 2023

(54) CROSS-LAYER ANOMALY DETECTION IN INDUSTRIAL CONTROL NETWORKS

(71) Applicant: ELTA SYSTEMS LTD., Ashdod (IL)

(72) Inventor: Avi ATZUR, Holon (IL)

(21) Appl. No.: 18/026,701

(22) PCT Filed: Jun. 9, 2022
(86) PCT No.: PCT/IL2022/050614

§ 371 Date: Mar. 16, 2023

(30) Foreign Application Priority Data
Jul. 1, 2021 (IL) 284559

(51) Int. Cl. G06F 21/55; H04L 41/069; G05B 19/042

(52) U.S. Cl. CPC G06F 21/55; H04L 41/069; G05B 19/042

(57) ABSTRACT

A processing circuitry based method of detecting an anomaly in operation of an industrial control system (ICS), comprising: receiving first data derivative of signaling between a logic controller (LC) and an associated sensing/actuating component, wherein the signaling was detected by a sensor/actuator I/O line signal monitor that is operably connected to a line of communication between a sensing/actuating component and an LC of the ICS; receiving, second data derivative of at least one of: one or more ICS network control packets, one or more statuses logged by an ICS application, and one or more commands entered to an ICS application; and determining whether there is inconsistency between the first data and the second data.

### TECHNICAL FIELD

The presently disclosed subject matter relates to cybersecurity, and in particular to methods for detecting anomalous activity in an industrial control network.

### BACKGROUND

Problems of detecting anomalous activity in industrial control networks have been recognized in the conventional art and various techniques have been developed to provide solutions.

### GENERAL DESCRIPTION

According to one aspect of the presently disclosed subject matter there is provided a method of detecting an anomaly in operation of an industrial control system (ICS), the method comprising:
a) receiving, by a processing circuitry, first data, the first data being derivative of signaling between a logic controller (LC) and an associated sensing/actuating component, wherein the signaling was detected by a sensor/actuator I/O line signal monitor that is operably connected to a line of communication between a sensing/actuating component and an LC of the ICS;
b) receiving, by the processing circuitry, second data derivative of at least one of:
   i) one or more ICS network control packets,
   ii) one or more statuses logged by an ICS application, and
   iii) one or more commands entered to an ICS application,
c) determining, by the processing circuitry, whether there is inconsistency between the first data and the second data.

In addition to the above features, the method according to this aspect of the presently disclosed subject matter can comprise one or more of features (i) to (ix) listed below, in any desired combination or permutation which is technically possible:
(i) wherein the method additionally comprises:
   d) responsive to whether the processing circuitry determined inconsistency, performing, by the processing circuitry, an alert action
(ii) wherein the method additionally comprises:
   d) responsive to whether the processing circuitry determined inconsistency, determining, by the processing circuitry, whether the inconsistency is indicative of a cyber attack; and
   e) responsive to whether the processing circuitry determined that the inconsistency is indicative of a cyber attack, performing, by the processing circuitry, an alert action.
(iii) the determining whether there is inconsistency between the first data and the second data comprises:
   a) decoding at least part of first data, thereby giving rise to, at least, data indicative of a first sensing/actuating event;
   b) determining one or more correlated ICS network events from the second data; and
   c) determining whether the one or more correlated ICS network events are inconsistent with the first sensing/actuating event.
(iv) the determining whether there is inconsistency between the first data and the second data comprises:
   a) determining a first ICS event from the second data;
   b) determining one or more correlated sensing/actuating events from the first data; and
   c) determining whether the one or more correlated sensing/actuating events are inconsistent with the first ICS event.
(v) the first data comprises data indicative of a voltage-to-time vector.
(vi) the first data comprises data indicative of a current-to-time vector.
(vii) the second data comprises data derivative of one or more ICS network control packets which comprise supervisory control and data acquisition (SCADA) data.
(viii) the second data comprises data derivative of status information logged by a SCADA human-machine interface (HMI) system.
(ix) the second data comprises data derivative of commands entered to a SCADA human-machine interface (HMI) system.

According to another aspect of the presently disclosed subject matter there is provided a system of detecting an anomaly in operation of an industrial control system (ICS), the system comprising a processing circuitry configured to:
a) receive first data, the first data being derivative of signaling between a logic controller (LC) and an associated sensing/actuating component, wherein the signaling was detected by a sensor/actuator I/O line signal monitor that is operably connected to a line of communication between a sensing/actuating component and an LC of the ICS;
b) receive second data derivative of at least one of:
   i) one or more ICS network control packets,
   ii) one or more statuses logged by an ICS application, and
   iii) one or more commands entered to an ICS application; and
c) determine whether there is inconsistency between the first data and the second data.

This aspect of the disclosed subject matter can further optionally comprise one or more of features (i) to (ix) listed above with respect to the method, mutatis mutandis, in any desired combination or permutation which is technically possible.

According to another aspect of the presently disclosed subject matter there is provided a computer program product comprising a computer readable non-transitory storage medium containing program instructions, which program instructions when read by a processor, cause the processing circuitry to perform a method of detecting an anomaly in operation of an industrial control system (ICS), the method comprising:
a) receiving, by a processing circuitry, first data, the first data being derivative of signaling between a logic controller (LC) and an associated sensing/actuating component, wherein the signaling was detected by a sensor/actuator I/O line signal monitor that is operably connected to a line of communication between a sensing/actuating component and an LC of the ICS;
b) receiving, by the processing circuitry, second data derivative of at least one of:
   i) one or more ICS network control packets,
   ii) one or more statuses logged by an ICS application, and
   iii) one or more commands entered to an ICS application; and
c) determining, by the processing circuitry, whether there is inconsistency between the first data and the second data.

This aspect of the disclosed subject matter can further optionally comprise one or more of features (i) to (ix) listed above with respect to the method, mutatis mutandis, in any desired combination or permutation which is technically possible.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1A illustrates an example deployment of a prior art industrial control system;

FIG. 1B illustrates an example deployment of an industrial control system together with a cross-layer anomaly detection system, according to some embodiments of the presently disclosed subject matter;

FIG. 2 illustrates a block diagram of an example cross-layer anomaly detection system, according to some embodiments of the presently disclosed subject matter; and

FIG. 3 illustrates a flow diagram of an example method of detecting anomalous behavior in an industrial control system, according to some embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “comparing”, “determining”, “calculating”, “receiving”, “providing”, “obtaining”, “utilizing”, “augmenting”, “correlating”, “alerting” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the processor, mitigation unit, and inspection unit therein disclosed in the present application.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

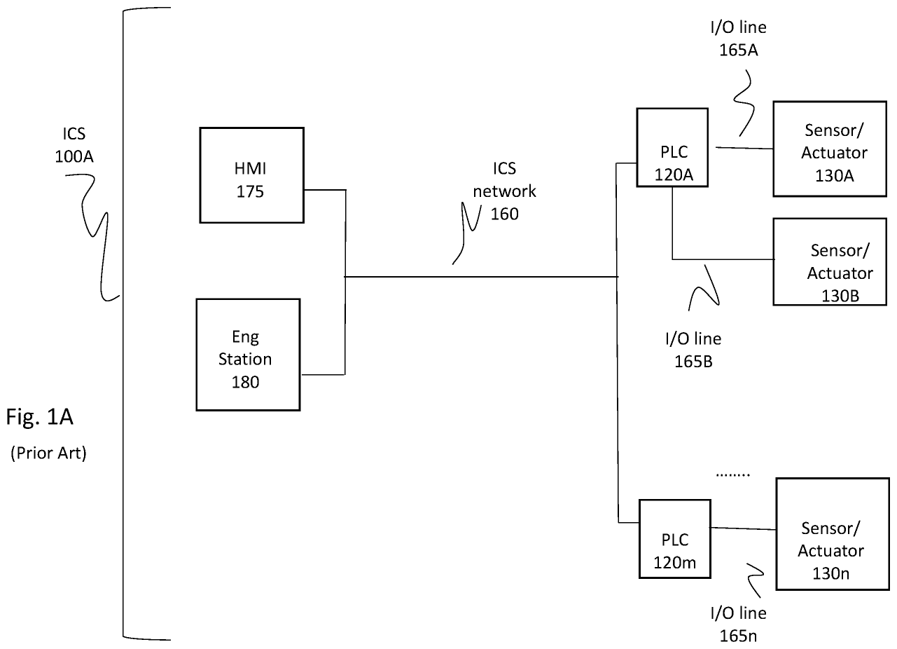

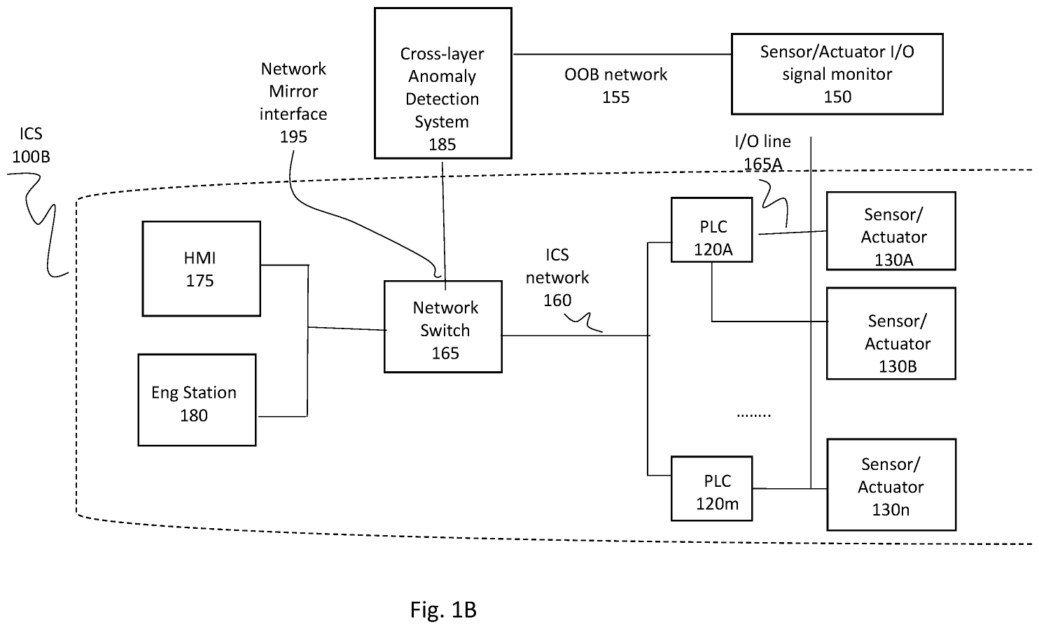

Attention is now directed to FIG. 1A, which illustrates an example prior art industrial control system (ICS).

ICS 100A can be configured, for example, to monitor and/or control an industrial process such as generation of electricity, control of a reservoir, manufacturing of a product etc.

ICS 100A can include one or more sensor/actuators 130A 130B 130n. A sensor/actuator 130A 130B 130n can be, for example, a sensing device that measures or monitors a particular characteristic of a process, e.g. a current temperature, a current speed of a rotating turbine etc. A sensor/actuator 130A 130B 130n can also be, for example, an actuating device e.g. for opening/closing a valve, increasing/decreasing the flow of a component substance to a chemical process etc. There can be any number of sensor/actuators in the ICS.

ICS 100A can include one or more programmable logic controllers (PLCs) 120A 120m. A PLC 120A 120m can be a processing device e.g. an application specific integrated circuit (ASIC), or it can be a microcontroller or other computer that is executing software. A Logic Controller (LC) is a generic term that encompasses PLCs and emphasizes that the controlling device need not actually be programmable. In the current description, the term PLC is used for familiarity, and includes any kind of LC.

A PLC 120A 120m can be operably connected to one or more sensor/actuators 130A 130B 130n via one or more input/output (I/O) lines 165A 165B 165n. In the non-limiting example ICS of FIG. 1A, PLC 120A is operably connected to sensor/actuators 130A 130B via I/O lines 165A and 165B respectively.

I/O lines 165A 165B 165n can be, for example, physical connectors suitable for transfer of, for example, actuator instructions and/or sensor data between sensor/actuators 130A 130B 130n and operably connected PLCs 120A 120m (e.g. shielded copper wire).

In some embodiments, an I/O line of I/O lines 165A 165B 165n carries discrete indicators or commands (e.g. indicating whether a water valve is open or closed). In some embodiments, an I/O line of I/O lines 165A 165B 165n carries scalar values (e.g. indicating a temperature or a pressure value). In some embodiments, some I/O lines carry analog signals, and other I/O lines carry discrete signals.

In some embodiments, signaling on an I/O line is based on voltage e.g. a voltage above 22 Volts (V) can indicate a discrete “1” and a voltage below 2V can indicate a discrete “0”.

In some embodiments, signaling on an I/O line is based on current e.g. a current value of 4 milliamp (mA) can indicate 0% of a scaled value of a parameter such as temperature, and a current value of 8 mA can indicate 25% etc.

PLCs 120A 120m can perform monitoring and/or control of operably connected sensor/actuators 130A 130B 130n—in accordance with, for example, logic built in to the PLC, or in accordance with installed software.

In the non-limiting example shown in FIG. 1A, PLC 120A monitors and/or controls both sensor/actuator 130A and sensor/actuator 130B, whereas PLC 120m controls and/or monitors sensor/actuator 130n. It will be understood that an ICS 100A can include various numbers and sensors/actuators, PLCs, and other components, as well as various arrangements thereof.

PLCs 120A 120m can be operably connected to ICS network 160. PLCs 120A 120m can transmit/receive e.g. control/monitoring data to/from other devices connected to ICS network 160. By way of non-limiting example: PLCs 120A 120m can exchange message of an ICS control protocol—e.g. supervisory control and data acquisition (SCADA)—with human machine interface (HMI) 175.

ICS network 160 can be a suitable type of wired, wireless, or hybrid communications network such as copper or fiber ethernet, WiFi, cellular, combinations thereof etc.

Human machine interface (HMI) 175 can be, for example, a computer configured to retrieve, set and view settings and status parameters of connected devices (such as PLCs 120A 120m and sensor/actuator 130A 130B 130n), and to view reports and system objects.

Human machine interface (HMI) 175 can send/receive ICS data (such as SCADA control and monitoring data) to/from PLCs 120A 120m.

Engineering station 180 can be, for example, a computer configured for programming PLCs 120A 120m.

Attention is now directed to FIG. 1B, which illustrates an example industrial control system (ICS) including a cross-layer ICS anomaly detection system, in accordance with some embodiments of the presently disclosed subject matter.

In recent years, industrial control systems have increasingly been subject to cyberattacks. Notable examples of such attacks include: the 2015 attack on the Ukrainian powergrid, and the 2021 attack on the American Colonial oil pipeline.

Attacks against ICSes can involve installing malware in different components of the network (e.g. in programmable logic controllers), so that malicious commands can be given to sensor/actuators, or to misrepresent indications being generated by sensor/actuators.

Some embodiments of the presently disclosed subject matter include a cross-layer anomaly detection system, as well as one or more devices for continuously monitoring I/O signal level exchanges (herein termed “level 0” data) between sensors/actuators and PLCs of an industrial control network.

The cross-layer anomaly detection system can collect:
a) signal monitor (i.e. “level 0”) data
b) control protocol packets (“level 1 data”) from the ICS network
c) application level data (e.g. log data or “level 2 data”) from devices which receive or generate control protocol packets

The cross-layer anomaly detection system can correlate events indicated in the distinct sources of data to detect discrepancies that can be indicative of cyberattacks (such as malware) on the ICS.

Among the advantages of some embodiments of the presently disclosed subject matter is the detection of cyberattacks that might avoid other means of detection.

ICS 100B is based on example ICS 100A. However, ICS 100B can further include cross-layer anomaly detection system 185 as well as other components—including sensor/actuator I/O signal monitor 150—to facilitate detection of anomalies (e.g. cyberattacks).

Sensor/actuator I/O signal monitor 150 can be operably connected to one or more I/O lines 165A 165B. In some ICS embodiments, there can be multiple instances of PLC I/O signal monitor 150, wherein each instance is operably connected to a subset of the I/O lines (for example: each instance can be operably connected to a single I/O line).

Sensor/actuator I/O signal monitor 150 can be a device configured to collect data that is derivative of signaling on an I/O line. For example: sensor/actuator I/O signal monitor 150 can collect data based on signals from a PLC to an operably connected sensor/actuator and/or signals from a sensor/actuator to an operably connected PLC.

By way of non-limiting example: sensor/actuator I/O signal monitor 150 can periodically measure voltages on an I/O line 165A 165B (e.g. on shielded copper wire or other media). Sensor/actuator I/O signal monitor 150 can then—for example—store or transmit the measurement of voltage (or a value derived from the measurement of voltage)—thereby giving rise to a vector indicative of a voltage-to-time measurement of the particular I/O line.

By way of a further non-limiting example: sensor/actuator I/O signal monitor 150 can periodically measure current on an I/O line 165A 165B (e.g. on shielded copper wire or other media). Sensor/actuator I/O signal monitor 150 can then, for example, store or transmit the measurement of current (or a value derived from the measurement of current), thereby giving rise to a vector indicative of a current-to-time measurement of the particular I/O line.

In a case where an I/O line is bidirectional, sensor/actuator I/O signal monitor 150 can collect data derivative of signaling in one direction, or in two directions. If sensor/actuator I/O signal monitor 150 collects data derivative of signaling in one direction, a second instance of sensor/actuator I/O signal monitor 150 can collect data derivative of signaling in the other direction.

The data that sensor/actuator I/O signal monitor 150 collects can be indicative of, for example,=a control instruction, or a sensed measurement at a sensor/actuator 130A 130B 130n. For example: voltage-to-time data collected from an I/O line connection that is signaling from PLC 120A 120m to a respective sensor/actuator 130A 130B 130n can be indicative of a control instruction (e.g. “open valve”). Similarly: voltage-to-time data collected from an I/O line connection that is signaling from sensor/actuator 130A 130B 130n to an operably connected PLC 120A 120m can be indicative of a sensed measurement (e.g. a current pressure or temperature value).

Sensor/actuator I/O signal monitor 150 can be operably connected to out-of-band network 155. Sensor/actuator I/O signal monitor 150 can provide data (e.g. collected data indicative of control instructions and/or sensed measurements at a sensor/actuator 130A 130B 130n) over out-of-band network 155. For example, sensor/actuator I/O signal monitor 150 can provide data to cross-layer anomaly detection system 185.

Out-of-band network 155 can be any kind of suitable wired, wireless, or hybrid communication network (ethernet, cellular etc.)

Utilization of out-of-band network 155 for communication between sensor/actuator I/O signal monitor 150 and cross-layer anomaly detection system 185 can prevent potential compromise of the communication by any malware which may be located inside ICS 100B. Nonetheless, in some embodiments, sensor/actuator I/O signal monitor 150 and cross-layer anomaly detection system 185 can communicate via ICS network 160 using, for example, suitable network topologies and/or encryption technologies.

In some embodiments, sensor/actuator I/O signal monitor 150 can be a “hardware data collector” as described in U.S. Pat. No. 10,698,378.

In addition to receiving signal monitor data, cross-layer anomaly detection system 185 can further receive packet data traversing ICS network 160 (e.g. SCADA data exchanged between HMI 175 and PLCs 130A 120m). In some embodiments, ICS network 160 includes a network switch 165 which in turn includes a network mirror interface 195. Network switch 165 can be configured to forward all received packet traffic onto network mirror interface 195, so that cross-layer anomaly detection system 185 can receive, for example, a copy of every packet that traverses ICS network 160.

Packet data received by cross-layer anomaly detection system 185 (e.g. SCADA data exchanged between HMI 175 and PLCs 130A 120m) can be indicative of ICS network events such as control instructions directed to a sensor/actuator 130A 130B 130n or sensed measurements originating at a sensor/actuator 130A 130B 130n.

Cross-layer anomaly detection system 185 can correlate ICS network events indicated by received packet data with ICS network events indicated by data collected by sensor/actuator I/O signal monitor 150, as will be described below.

Cross-layer anomaly detection system 185 can receive application data from, for example, engineering station 180. The term “application data” as used herein includes data generated by an application such as HMI 175 or engineering station 180 that generates and/or processes ICS control protocol.

By way of non-limiting example, engineering station 180 can generate log data indicative of, for example, control instructions (such as firmware updates) entered by a human and directed to a sensor/actuator 130A 130B 130n or sensed measurements originating at a sensor/actuator 130A 130B 130n and displayed on engineering station 180. Engineering station 180 can, for example, transmit the log data to cross-layer anomaly detection system 185 via ICS network 160.

Cross-layer anomaly detection system 185 can correlate ICS network events indicated by received application data with ICS network events indicated by received packet data, as well as data collected by sensor/actuator I/O signal monitor 150, as will be described below.

It is noted that the teachings of the presently disclosed subject matter are not bound by the system described with reference to FIG. 1B. Equivalent and/or modified functionality can be consolidated or divided in another manner and can be implemented in any appropriate combination of software with firmware and/or hardware and executed on a suitable device. For example, sensor/actuator I/O signal monitor 150 can be a standalone entity, or integrated, fully or partly, with other entities.

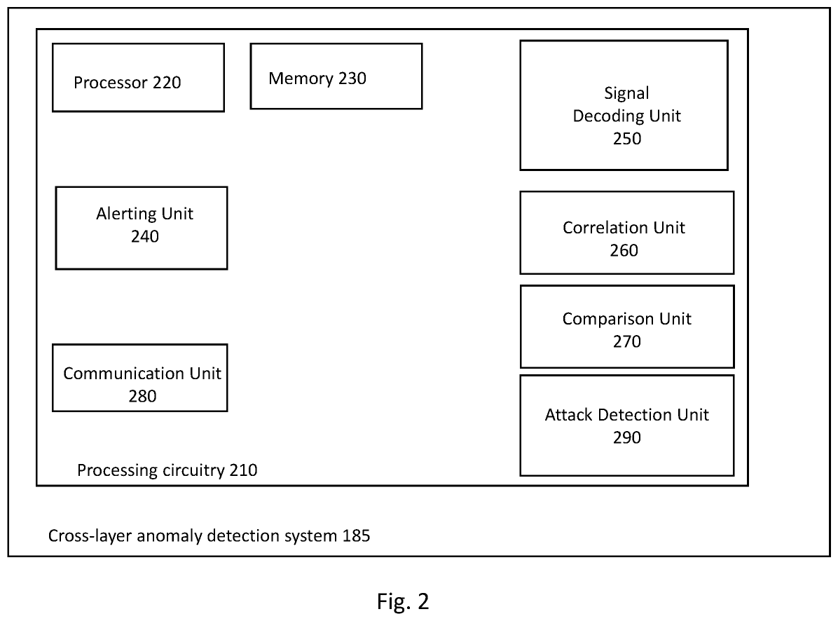

Attention is now directed to FIG. 2, which illustrates an example block diagram of a cross-layer ICS anomaly detection system, in accordance with some embodiments of the presently disclosed subject matter.

Cross-layer anomaly detection system 185 can include a processing circuitry 210. Processing circuitry 210 can include a processor 220 and a memory 230.

Processor 220 can be a suitable hardware-based electronic device with data processing capabilities, such as, for example, a general purpose processor, digital signal processor (DSP), a specialized Application Specific Integrated Circuit (ASIC), one or more cores in a multicore processor, etc. Processor 220 can also consist, for example, of multiple processors, multiple ASICs, virtual processors, combinations thereof etc.

Memory 230 can be, for example, a suitable kind of volatile and/or non-volatile storage, and can include, for example, a single physical memory component or a plurality of physical memory components. Memory 230 can also include virtual memory. Memory 230 can be configured to, for example, store various data used in computation.

Processing circuitry 210 can be configured to execute several functional modules in accordance with computer-readable instructions implemented on a non-transitory computer-readable storage medium. Such functional modules are referred to hereinafter as comprised in the processing circuitry. These modules can include, for example, signal decoding unit 250, correlation unit 260, comparison unit 270, alerting unit 240, and communication unit 280.

Communication unit 280 can control communication over, for example, out-of-band network 155 and network mirror interface 195. Communication unit 280 can be one or more suitable communication controllers for appropriate communications media.

Signal decoding unit 250 can receive, for example via communication unit 280, data collected by instances of sensor/actuator I/O signal monitor 150. As described above, this collected data can be derivative of signaling on I/O lines 165A 165B 165n and can be indicative of ICS network events such as control instructions being applied to sensor/actuators 130A 130B 130n, or sensed events from sensor/actuators 130A 130B 130n.

Signal decoding unit 250 can process data received from instances of sensor/actuator I/O signal monitor 150 by, for example, decoding it to sensor/actuator events.

In some embodiments, signal decoding unit 250 decodes a voltage-to-time vector by digitizing it i.e. converting the recorded voltages over time to a series of signal bits in accordance with a signaling mechanism being used on a respective input or output line. In some embodiments, signal decoding unit 250 then maps the decoded signal bits to, for example, a command transmitted from a PLC 120A 120m to a sensor/actuator 130A 130B 130n or a sensed measurement transmitted from a sensor/actuator 130A 130B 130n to an operably connected PLC 120A 120m.

By way of non-limiting example, in some embodiments signal decoding unit 250 can decode a voltage-to-time vector of an output connection to a digital ‘1’, and can determine that on the particular instance of I/O line 165A 165B 165n digital ‘1’ constitutes a command to open a valve.

By way of further non-limiting example, in some embodiments signal decoding unit 250 can decode a voltage-to-time vector of an input connection to a 3-bit digital value equivalent to a value ‘7’, and can determine that on the particular instance of I/O line 165A 165B 165n value constitutes a particular value of a pressure reading.

In some other embodiments, digitizing utilizes current-to-time vectors rather than voltage-to-time vectors.

In some other embodiments, digitizing uses other suitable signal processing methods.

In some other embodiments, signal decoding unit 250 determines signaled sensor/actuator events from the collected data without first digitizing.

Correlation unit 260 can correlate events detected in the signal data collected with events detected in packet data and/or events detected in application log data.

Upon signaling of a sensed event by a sensor/actuator to an operably connected PLC, signal monitor 150 can collect data and transmit it to cross-layer anomaly detection system 185 via out-of-band network 155. A PLC 120A 120m can (for example: concurrently) prepare a packet indicative of the sensed event (e.g. a SCADA packet) for transmission on ICS network 160 to (for example) HMI 175, which can then transmit application log data to cross-layer anomaly detection system 185. Additionally, the packet indicative of the sensed event can be copied by network switch 165 and sent via network mirror interface 195 to cross-layer anomaly detection system 185.

Consequently, arrival of signal monitor data indicative of a sensed event at cross-layer anomaly detection system 185 can be earlier or later than arrival of packet data and of application log data indicating the same events, as the transmission paths of signal data, packet data, and HMI logging can have different latencies. Accordingly, correlation unit 260 can accumulate and store signaling data, packet data, and/or application log data (for example in memory 230 or non-volatile storage (not shown)) before performing correlation. Correlation unit 260 can store these data either as originally received, or can store these data after processing (e.g. correlation unit 260 can store data indicative of sensor/actuator events detected in the signal monitor data).

Comparison unit 270 can assess whether an event detected in the signal monitor data is consistent with a correlated event indicated packet data and/or application log data.

By way of non-limiting example, if signal decoding unit 250 detected an event of a sensed “temperature reading” with a particular temperature value, but SCADA packet data and/or application log data (for example: from HMI 175) indicated a different temperature value, comparison unit 270 can assess these events as inconsistent.

By way of further non-limiting example, if SCADA packet data and/or application log data (for example: from HMI 175) indicate a control instruction to open a valve, but signal decoding unit 250 detected, in the signal data, a control instruction to close the valve, comparison unit 270 can assess these events as inconsistent.

In some embodiments, if the event detected in the signal monitor data is not consistent with the correlated events, then an alert can be raised.

In some embodiments, if the event detected in the signal monitor data is not consistent with the correlated events, attack detection unit 290 can then determine whether the inconsistency is indicative of a cyberattack (as opposed to—for example—a packet loss or other operational failure. In some such embodiments, if the inconsistency is determined to be indicative of a cyberattack, then an alert can be raised.

Alerting unit 240 can perform an actual alert, for example to a human operator, in an event where comparison unit 270 (for example) detects an inconsistency or when attack detection unit 290 has detected a cyberattack. By way of non-limiting example, alerting unit 240 can activate a hardware emergency indicator, write a message on a monitor screen, send a message to an operator's mobile device etc.

It is noted that the teachings of the presently disclosed subject matter are not bound by the system described with reference to FIG. 2. Equivalent and/or modified functionality can be consolidated or divided in another manner and can be implemented in any appropriate combination of software with firmware and/or hardware and executed on a suitable device. For example, cross-layer anomaly detection system 185 can be a standalone entity, or integrated, fully or partly, with other entities.

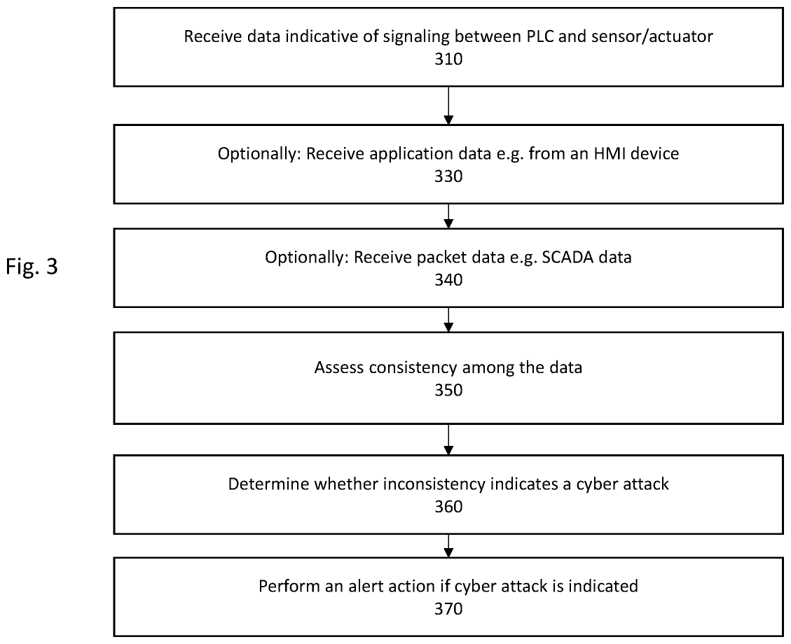

Attention is now directed to FIG. 3, which illustrates a flow diagram of an example method of detecting anomalous behavior in an industrial control system, in accordance with some embodiments of the presently disclosed subject matter.

Cross-layer anomaly detection system 185 (for example: communication unit 280) can receive (310) data derivative of signaling between PLC and sensor/actuator. This data can be received, for example, from a sensor/actuator I/O signal monitor 150.

As described above with reference to FIG. 1B, a sensor/actuator I/O signal monitor 150 can be operably attached to an I/O line 165A. A sensor/actuator I/O signal monitor 150 can then collect and transmit (e.g. to cross-layer anomaly detection system 185) data indicative of signaling between PLC and sensor/actuator (input-direction signaling, output-direction signaling, or both). The transmitted data can be, for example, in the form of a vector indicating time-to-voltage or time-to-current (or data derived from time-to-voltage or time-to-current). The transmitted data can also be in the form of digitized or quantized signals.

Cross-layer anomaly detection system 185 (for example: signal decoding unit 250) can decode the received signaling data, thereby giving rise to data indicative of a sensing/actuating event.

In some embodiments the received data indicative of signaling between a PLC and sensor/actuator is a sequence of one or more bits that were signaled from (or to) the PLC.

In some embodiments the received data derivative of signaling between PLC and sensor/actuator is a representation of analog data (e.g. vector data indicating a time-to-voltage measurement mapping). In some such embodiments, cross-layer anomaly detection system 185 (for example: signal decoding unit 250) can first digitize the received data before decoding it to data indicative of a sensing/actuating event. In other such embodiments, cross-layer anomaly detection system 185 (for example: signal decoding unit 250) can perform decoding based on the representation of the analog data.

Cross-layer anomaly detection system 185 (for example: signal decoding unit 250) can then decode the received signal monitor data (or other data derived from the signal monitor data) to e.g. one or more control instructions or sensed events, for example, in accordance with particular sensors/actuators and data formats/control protocols (which can indicate e.g. temperature, on/off value etc.) implemented by particular PLCs.

Optionally, cross-layer anomaly detection system 185 (for example: communication unit 280) can receive (330) application data e.g. from an HMI 175 system or other ICS application The ICS application data can include, for example, logged status information (e.g. data derivative of statuses such as ICS events received), data derivative of commands entered to the ICS application, etc.

Optionally, cross-layer anomaly detection system 185 (for example: communication unit 280) can receive (340) control packet data from the ICS (e.g. instructions or sensed events indicated in a control protocol such as SCADA).

Cross-layer anomaly detection system 185 (for example: comparison unit 270) can next assess (350) consistency between signal monitor data on the one hand, and the ICS packet data and/or the application data on the other hand.

In some embodiments, cross-layer anomaly detection system 185 (for example: comparison unit 270) can determine assess consistency (and, implicitly, whether there is inconsistency) by executing a method in accordance with the following steps:
a) cross-layer anomaly detection system 185 (for example: signal decoding unit 250) can decode at least part of the received signal monitor data, for example by using decoding methods as described above. The decoding can result in, at least, data indicative of a sensing/actuating event (such as a sensed temperature sent from a sensing/actuating component to an operably connected PLC, or a command to open a valve being sent from a PLC to a sensor/actuator) that has taken place.
b) Cross-layer anomaly detection system 185 (for example: correlation unit 260) can determine one or more correlated ICS network events from the received ICS network packet data and/or received ICS application data. ICS network events include events that take place within an ICS network e.g. a PLC transmittal of a SCADA packet indicating a particular sensor reading, or an HMI logging of an operator command to activate or deactivate a PLC-controlled sensor/actuator.
   In this context, referring to an ICS network event as “correlated” to a particular sensing/actuating event, can indicate that the particular SCADA network packet, HMI log entry etc. is expected to reflect the particular sensing/actuating event (either directly or indirectly).
   It is noted that, in some embodiments, whether an ICS network event is correlated to a particular sensing/actuating event can depend on timing e.g. a cross-layer anomaly detection system 185 (for example: correlation unit 260) can determine that a SCADA network packet is correlated to a temperature reading event if a certain amount of time has passed from the signaling of the temperature reading from a sensor/actuator to a PLC.
   It is further noted that whether an ICS network event is correlated to a particular sensing/actuating event can depend on various factors that are specific to the ICS network and its specific configuration and use cases.
c) Cross-layer anomaly detection system 185 (for example: comparison unit 270) can determine whether the one or more correlated ICS events are consistent/inconsistent with the sensing/actuating event.
   By way of non-limiting example, if cross-layer anomaly detection system 185 (for example: signal decoding unit 250) decoded a sensed event of “temperature reading” with a particular temperature value, but a correlated SCADA packet data indicated a different temperature value, cross-layer anomaly detection system 185 (for example: comparison unit 270) can assess these events as inconsistent. The inconsistency can be due to, for example, malware which tampered with the control protocol to misrepresent the temperature value.

In some embodiments, cross-layer anomaly detection system 185 (for example: comparison unit 270) can determine assess consistency (and, implicitly, whether there is inconsistency) by executing a method in accordance with the following steps:
a) Cross-layer anomaly detection system 185 (for example: comparison unit 270) can determine an ICS network event (e.g. an operator generating a command to open a valve) from the received network packet data and/or received ICS application data.
b) Cross-layer anomaly detection system 185 (for example: signal decoding unit 250) can decode one or more correlated sensing/actuating events from the signal monitor data (e.g. using decoding methods described above). As above, the sensing/actuating events can be referred to as “correlated” if it is expected to reflect the particular ICS network event. As noted above, the determination of which events are “correlated” is dependent on the configuration of the ICS and its use cases.
c) Cross-layer anomaly detection system 185 (for example: comparison unit 270) can determine whether the one or more correlated sensing/actuating events are inconsistent with the first ICS event.
By way of non-limiting example, if cross-layer anomaly detection system 185 (for example: communication unit 280) received a logged message from an HMI 175 indicating that an operator entered a command for a particular PLC (e.g. to open a particular valve), whereas a correlated sensing/actuating event decoded from signal monitor data indicated that the command was e.g. to close the valve, cross-layer anomaly detection system 185 (for example: comparison unit 270) can assess these events as inconsistent. The inconsistency can be due to, for example, malware which tampered with the control protocol to misrepresent the control command.

In some embodiments, if cross-layer anomaly detection system 185 (for example: if signal decoding unit 250) decoded a sensing/actuating event (e.g. a component failure) from signal monitor data, but cross-layer anomaly detection system 185 (for example: comparison unit 270) determines that an expected correlated ICS network event in

SCADA packet data and/or HMI application data (e.g. an ICS network event reporting the component failure) is not present, cross-layer anomaly detection system 185 (for example: comparison unit 270) can assess these events as inconsistent. The inconsistency can be due to, for example, malware which disrupted the report of an event. In this case however, the inconsistency may be due to operational failure or packet loss.

In some embodiments, if cross-layer anomaly detection system 185 (for example: communication unit 280) received an ICS control packet and/or HMI application data indicative of a particular ICS network event (e.g. an operator issuing a command to deactivate a component) but cross-layer anomaly detection system 185 (for example: comparison unit 270) determines that an expected correlated sensing/actuating event (e.g. a signal to perform the deactivation) is not present in signal monitor data, cross-layer anomaly detection system 185 (for example: comparison unit 270) can assess these events as inconsistent. The inconsistency can be due to, for example, malware which disrupted the performance of a command. In this case however, the inconsistency may be due to operational failure or packet loss.

If inconsistency was in fact detected, cross-layer anomaly detection system 185 (for example: attack detection unit 290) can determine (360) whether the inconsistency is indicative of a cyber attack (for example: using criteria described hereinabove, or as known in the art).

Cross-layer anomaly detection system 185 (for example: alerting unit 240) can perform (370) an alert action if a cyber attack is indicated. In some embodiments, cross-layer anomaly detection system 185 does not determine whether the inconsistency is indicative of a cyber attack. In some such embodiments, Cross-layer anomaly detection system 185 (for example: alerting unit 240) can perform (370) an alert action responsive to an inconsistency being detected between signal monitor data on the one hand, and the ICS packet data and/or the application data on the other hand.

It is noted that the teachings of the presently disclosed subject matter are not bound by the flow diagram illustrated in FIG. 3, and that in some cases the illustrated operations may occur concurrently or out of the illustrated order (for example: operations 310 and 320 can be reversed). It is also noted that whilst the flow chart is described with reference to elements of the system of FIG. 2, this is by no means binding, and the operations can be performed by elements other than those described herein.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A method of detecting an anomaly in operation of an industrial control system (ICS), the method comprising:
a) receiving, by a processing circuitry, first data, the first data being derivative of signaling between a logic controller (LC) and an associated sensing/actuating component, wherein the signaling was detected by a sensor/actuator I/O line signal monitor that is operably connected to a line of communication between a sensing/actuating component and an LC of the ICS;
b) receiving, by the processing circuitry, second data derivative of at least one of:
i) one or more ICS network control packets,
ii) one or more statuses logged by an ICS application, and
iii) one or more commands entered to an ICS application; and
c) determining, by the processing circuitry, whether there is inconsistency between the first data and the second data.

2. The method of claim 1, additionally comprising:
d) responsive to whether the processing circuitry determined inconsistency, performing, by the processing circuitry, an alert action.

3. The method of claim 1, additionally comprising:
d) responsive to whether the processing circuitry determined inconsistency, determining, by the processing circuitry, whether the inconsistency is indicative of a cyber attack; and
e) responsive to whether the processing circuitry determined that the inconsistency is indicative of a cyber attack, performing, by the processing circuitry, an alert action.

4. The method of claim 1, wherein the determining whether there is inconsistency between the first data and the second data comprises:
a) decoding at least part of first data, thereby giving rise to, at least, data indicative of a first sensing/actuating event;
b) determining one or more correlated ICS network events from the second data; and
c) determining whether the one or more correlated ICS network events are inconsistent with the first sensing/actuating event.

5. The method of claim 1, wherein the determining whether there is inconsistency between the first data and the second data comprises:
a) determining a first ICS event from the second data;
b) determining one or more correlated sensing/actuating events from the first data; and
c) determining whether the one or more correlated sensing/actuating events are inconsistent with the first ICS event.

6. The method of claim 1, wherein the first data comprises data indicative of a voltage-to-time vector.

7. The method of claim 1, wherein the first data comprises data indicative of a current-to-time vector.

8. The method of claim 1, wherein the second data comprises data derivative of one or more ICS control packets which comprise supervisory control and data acquisition (SCADA) data.

9. The method of claim 1, wherein the second data comprises data derivative of status information logged by a SCADA human-machine interface (HMI) system.

10. The method of claim 1, wherein the second data comprises data derivative of commands entered to a SCADA human-machine interface (HMI) system.

11. A system of detecting an anomaly in operation of an industrial control system (ICS), the system comprising a processing circuitry configured to:
a) receive first data, the first data being derivative of signaling between a logic controller (LC) and an associated sensing/actuating component, wherein the signaling was detected by a sensor/actuator I/O line signal monitor that is operably connected to a line of communication between a sensing/actuating component and an LC of the ICS;
b) receive second data derivative of at least one of:
i) one or more ICS network control packets,
ii) one or more statuses logged by an ICS application, and
iii) one or more commands entered to an ICS application; and
c) determine whether there is inconsistency between the first data and the second data.

12. A computer program product comprising a computer readable non-transitory storage medium containing program instructions, which program instructions when read by a processing circuitry, cause the processing circuitry to perform a method detecting an anomaly in operation of an industrial control system (ICS), the method comprising:
a) receiving first data, the first data being derivative of signaling between a logic controller (LC) and an associated sensing/actuating component, wherein the signaling was detected by a sensor/actuator I/O line signal monitor that is operably connected to a line of communication between a sensing/actuating component and an LC of the ICS;
b) receiving second data derivative of at least one of:
i) one or more ICS network control packets,
ii) one or more statuses logged by an ICS application, and
iii) one or more commands entered to an ICS application; and
c) determining whether there is inconsistency between the first data and the second data.
